(19) United States
(12) Patent Application Publication
(10) Pub. No.: US 2025/0320387 A1
(43) Pub. Date: Oct. 16, 2025

(54) METHOD OF PRODUCING TERPENE-INFUSED GLUE AND TERPENE-INFUSED PRE-ROLLED CONES

(71) Applicant: PT. Mitra Prodin, Ketewel Village (ID)

(72) Inventors: Sherwin Wardhana RAHARDJO, Surabaya (ID); Arthur KARANGAN, Ketewel Village (ID)

(73) Assignee: PT. Mitra Prodin, Ketewel Village (ID)

(21) Appl. No.: 18/634,884

(22) Filed: Apr. 13, 2024

(51) Int. Cl. C09J 131/04; A24F 47/00; C08K 5/01; C08K 5/053; C09J 103/02

(52) U.S. Cl. CPC C09J 131/04; A24F 47/00; C08K 5/01; C08K 5/053; C09J 103/02

(57) ABSTRACT

A method is disclosed for combining terpenes mixed with the glue that is used in the process making of the pre-rolled cones. Another method is disclosed for terpene insertion heating method for pre-rolled cones infusion. Both methods will be applied to create a product that will last long enough to be consumed without excessive dissipation. In accordance with the various embodiments and aspects of the invention, a cap insert is disclosed that contains a concentrated terpene solid material and a system for infusing the terpene into the pre-rolled cones using a glass or plastic container for the packaging.

### TECHNICAL FIELD

The present technology relates to the manufacturing process of the pre-rolled cones, and more specifically, related to the manufacturing method of infused-pre-rolled cones with terpene derivative products and terpene glue.

### BACKGROUND

Pre-rolled cones are typically plain or not containing any bio active compounds. Based on the latest trends, bio active compounds, such as terpenes, have been claimed by the leaders and scientists in this industry to enhance the smoking experiences. The nicer sensation or the “entourage effect” has created a great demand to develop an innovation in pre-rolled cones an infused-terpene or any bio-active compounds into a pre-rolled cone. However, the manufacturers of pre-rolled cones have failed to effectively infuse terpenes or any bio active compounds to pre-rolled cones.

Therefore, what is needed is a method to combine terpene or any bio-active compounds with the glue, which is used in the process of making pre-rolled cones and is plain or not containing any bio active compounds. Additionally, what is needed is method to infuse the terpene or any bio-active compounds into pre-rolled cones using insertion heating methods. The methods disclosed herein to address the problems identified will result in infused pre-rolled cones that last long enough to be consumed without excessive dissipation.

### SUMMARY

In accordance with the various aspects and embodiments of the invention, a method is disclosed for combining terpene derivatives product and glue. In accordance with various aspects and embodiments of the invention, a method is introduced to mix terpenes with the starch based and or EVA (Ethyl Vinyl Acetate) glue. In accordance with the various aspects and embodiments of the invention, the terpene or any bio-active compounds are infused into pre-rolled cones using insertion heating methods. In accordance with the various aspects and embodiments of the invention, terpenes are infused in pre-rolled cones using a terpene container.

With these various aspects and embodiments, the infused pre-rolled cones will last long enough to be consumed without excessive dissipation. The method and system disclosed herein can be applied to, and are not limited to terpene derivative products. In accordance with the various aspects that embodiments of the invention, the various system and methods can also be applied to any bio-active compounds like flavonoids, alkaloids, and many more.

### BRIEF DESCRIPTION OF THE DRAWINGS

To understand the invention more fully, reference is made to the accompanying drawings. The invention is described in accordance with the aspects and embodiments in the following description with reference to the drawings or figures, in which like numbers represent the same or similar elements. Understanding that these drawings are not to be considered as having limitations in the scope of the invention, the present described aspects and embodiments are described with additional details through the use of the accompanying drawings.

FIG. 1 shows the chemical process for biosynthesis of terpenes.

FIG. 2 shows the head-to-tail coupling of isoprene units, and isoprene units in some terpenoid backbones.

FIG. 3 shows a table for the classification of terpenes.

FIG. 4A shows a composition table for a homogeneous terpene glue in accordance with the various aspects and embodiments of the present invention.

FIG. 4B shows a composition table for a homogeneous terpene glue in accordance with the various aspects and embodiments of the present invention.

FIG. 4C shows a standard curve of wood paper for terpene concentration in accordance with the various aspects and embodiments of the present invention.

FIG. 4D shows a standard curve of blunt paper for terpene concentration in accordance with the various aspects and embodiments of the present invention.

FIG. 5A shows a top view of an insert in accordance with the various aspects and embodiments of the present invention.

FIG. 5B shows a cross-section view along AA for the insert of FIG. 5A in accordance with the various aspects and embodiments of the present invention.

### DETAILED DESCRIPTION

The following figures describe various examples of the present technology that illustrate various aspects and embodiments of the invention. Generally, examples can be used to describe the aspects of the invention in any combination. All statements herein are reciting principles, aspects, and embodiments as well as specific examples thereof, which are intended to encompass both structural and functional equivalents. The examples provided are intended as non-limiting examples. Additionally, it is intended that such equivalents will include both currently known equivalents and equivalents developed in the future, i.e., any elements developed that perform the same function, regardless of structure. To the extent that the terms “including”, “includes”, “having”, “has”, “with”, or variants thereof are used in either the detailed description and the claims, such terms are intended to be inclusive in a similar manner to the term “comprising” as used in the claim that follows.

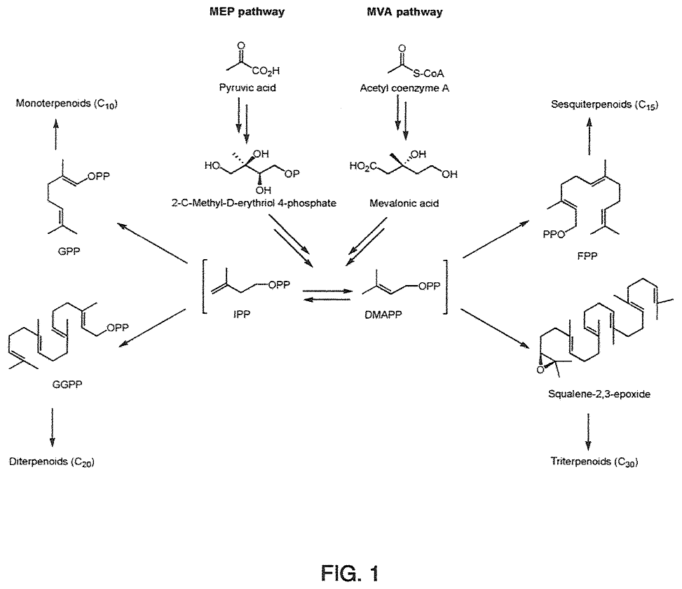

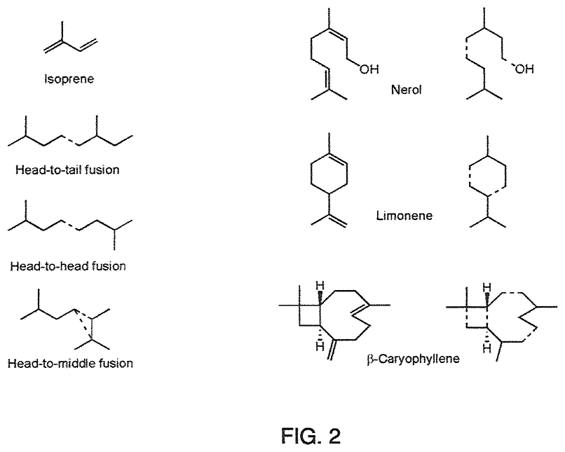

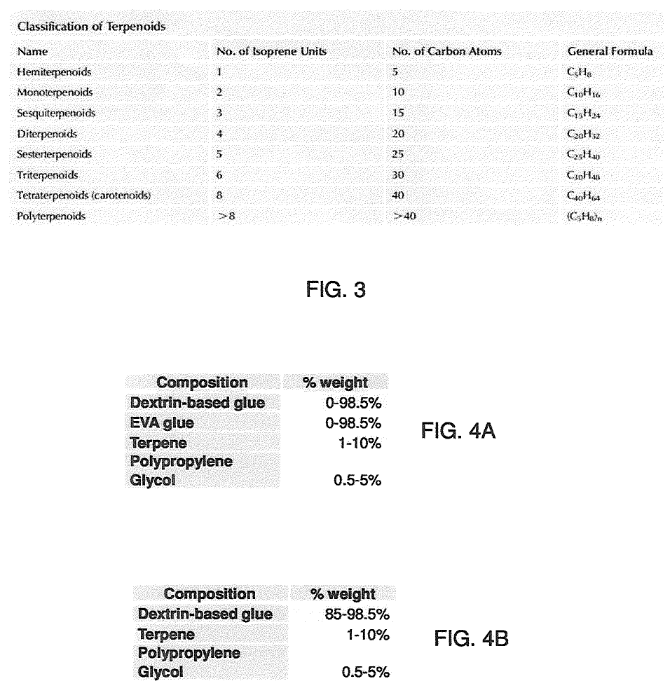

Referring now to FIG. 1, FIG. 2, and FIG. 3, various terpenes and chemical compositions are shown. In accordance with the various aspects and embodiments of the invention, terpenes are combined with the glue for creating sensation when the pre-rolled cones burn. Terpenes, also known as isoprenoids, are the most numerous and structurally diverse natural products that are part of bio active compounds. Terpenes are derived from the mevalonate (MVA) pathway, which is active in the cytosol, or from the plasticidal 2-C-methyl-D-erythriol 4-phosphate (MEP) pathway. Terpenes are classified based on the number and structural organization of carbons formed by the linear arrangement of isoprene units followed by cyclization and rearrangements of the carbon skeleton with an empirical feature known as the isoprene rule. The isoprene rule states that all terpenoids are derived from the ordered, head-to-tail joining of isoprene units. A head-to-tail fusion is the most common; however, nonhead-to-tail condensation of isoprene units also occur. Isoprene, the “building block” of terpenoids, is 2-methylbuta-1,3-diene (C5H8). The single isoprene unit, therefore, represents the most basic class of terpenoids, hemiterpenoids. The names of other terpenes groups are shown in FIG. 3. Head-to-head fusions are common among triterpenoids and carotenoids, while some compounds are formed by head-to-middle fusions (e.g., irregular monoterpenoids) [2,3]. FIG. 2 shows the most common fusions of isoprene units, and how the isoprene units and the original backbone can be traced in three sample terpenoids.

In accordance with the various aspects and embodiments of the invention, a method is disclosed for adding the terpene derivative products, to starch based glue and or EVA (Ethyl Vinyl Acetate) glue that is used in the creation of pre-rolled cones, thereby resulting in a terpene-infused glue. These two substances, terpene derivative products and the glue, typically are not homogeneous. Thus, combining terpene derivative products with the glue used for the pre-rolled cones making is disclosed herein.

In accordance with the various aspects and embodiments of the invention, the method includes using polypropylene glycol that acts as an emulsifier is helping the mixing process with the glue. Polypropylene glycol is used to stabilize the mixture of the water-based glue and the oil-based terpene derivative products.

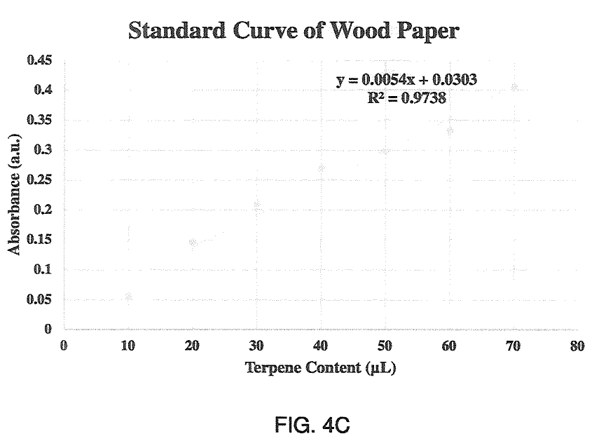

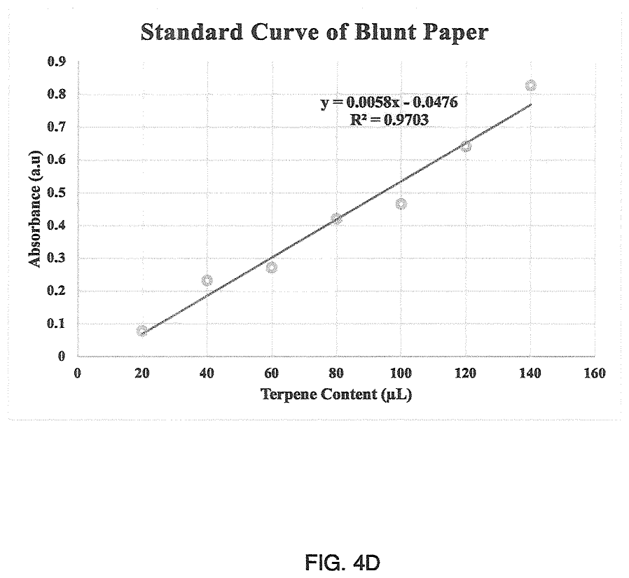

In accordance with the various aspects and embodiments of the invention, polypropylene glycol and terpene-containing flavor are mixed using a vortex mixer for a period of time, which can range from 3 minutes to 15 minutes, with an ideal time being close to 5 minutes. In accordance with the various aspects and embodiments of the invention, after mixing, the solution is poured into a starch based glue and or a EVA (Ethyl Vinyl Acetate) based glue with a predefined ratio that follows the composition in FIG. 4A and/or FIG. 4B, resulting in an initial combined solution.

In accordance with the various aspects and embodiments of the invention, a homogeneous mixture is one whose composition is uniform throughout the mixture. A homogenous mixture is the type of mixture where the composition is constant throughout or the components that make up the mixture are distributed uniformly. A homogeneous solution tends to be identical, no matter how it is sampled.

Referring again to FIG. 4A, in accordance with some embodiments and aspects of the invention, the resulting homogeneous solution composition has the following composition and % weight: Dextrin-based glue in the range of 0% to 98.5%; EVA glue in the range of 0% to 98.5%; Terpene derivatives product in the range of 1% to 10%; Polypropylene Glycol 0% to 5.5%. While the ranges are provided as possible variations, FIG. 4B provides a non-limiting example of possible ranges in accordance with the various embodiments and aspects of the invention for a range of combination mixtures. In accordance with the various embodiments of the invention, the composition includes various EVA glue composition, such that terpene glues can be made by dextrin and or EVA glue. The scope of the present invention is not limited to these exact percentage numbers or the type glues. There are various possible variations, which differ from these exact numbers, that allows a suitable mixture.

In accordance with the various aspects and embodiments of the invention, one or more of chloroform, methanol, and sulfuric acid (H2SO4) can be used to measure the terpene substances from dextrin-based glue. The Terpene concentration is determined by colorimetric procedure with modification. In accordance with the various aspects of the invention, 0.5 mL of the homogenous solution, which is the terpene glue, is homogenized with 3.5 mL of methanol at mixing frequency of 30 Hz for 5 minutes resulting in a methanol mix composition. The resulting methanol mix composition is then incubated for 48 hours in a darkroom and subsequently centrifuged force at 4000 G for 15 minutes to produce a supernatant. The unit designation “G” refers in this context refers to gravitational force, also known as relative centrifugal force (RCF). When a centrifuge is set to a certain speed in revolutions per minute (RPM) or angular velocity, the “G” value indicates how many times “the force of gravity” that the sample experiences during centrifugation. For example, if a centrifuge is set to 1500 g, it means that the sample experiences a force 1500 times greater than the force of gravity at the Earth's surface. This force is used to separate components of a sample based on their density. As noted, and in accordance with the various aspects of the invention, while 4000 G and 15 minutes are presented as an ideal time, the exact centrifuge force and duration of time can be varied from 1000 G-5000 G and range from 5 minutes to 25 minutes.

In accordance with the various aspects of the invention, a terpene infused pre-rolled cone sample mixed with 1.5 mL of chloroform inside 20 mL glass or plastic container. The sample is mixed using a vortex mixer for 3 mins. Then, take the chemical fluid leftover and acidified with 100 μL sulfuric acid (H2SO4). It should be incubated for 1.5 hours at room temperature and stored in a dark environment. As noted, and in accordance with the various aspects of the invention, while a specific amount of sulfuric acid is noted and incubated for 1.5 hours are presented as ideal, the exact amounts can be varied within a range, such as from 50 μL to 200 μL of sulfuric acid and from 30 minutes to 3 hours of incubation.

In accordance with the various aspects of the invention, after the incubation process, a reddish-brown precipitation is formed. The upper layer is taken out and the precipitation layer then is mixed with 2.8 mL of methanol. All the extracted samples are transferred to a 3 mL glass cuvette and subsequently analyzed by spectrophotometer with the wavelength at 538 nm. All the absorbance value generated by spectrophotometer then converted to terpene concentration (% v/v). In accordance with the various embodiments and aspects of the invention, FIG. 4C and FIG. 4D show terpene content in volume unit (μL).

In accordance with the various aspects of the invention, terpene concentration from the cap is infused into the pre-rolled cones using a glass or plastic container and a heating chamber with the temperature of 80° C. for 60 mins. The pre-rolled cones material refers to any woods paper and or blunts paper material. As noted, the exact temperature and time are provided as an ideal and can be varied within an acceptable range, for example 50° C. to 120° C. for 30 minutes to 2 hours. It should be noted, this system can use any container materials without size limitation.

In accordance with the various aspects of the invention, the terpene solution is prepared to mix with various chemical solutions, such as ethanol (EtOH) and polypropylene glycol (PPG), using a ratio of 1:1:1 in a solid material inside a cap that attached to the lid of a glass or plastic container. The process of infusing terpenes into pre-rolled cones is by using the modified glass container or plastic container, wherein the glass container lid is coated with the PTFE (Teflon) to prevent dissipation to the air or from being absorbed, other than by the pre-rolled cones. In accordance with the various aspects and embodiments of the invention, the coating material used for the container and/or the cap can be any non-porous or low porosity material. In accordance with the various aspects and embodiments of the invention, terpene derivative products are mixed with some fixative agents, such as PPG, coupled with ethanol (96%) with a ratio of 1:1, thus enhancing the concentration of the terpene inside the pre-rolled cone.

In accordance with the various aspects of the invention, with an infused concentration of 50 microliters, the highest terpene concentration detected in cone paper is an average of 30 microliter. In accordance with the various aspects and embodiments, the weight for pre-rolled cones is approximately 50 milligrams.

In accordance with the various aspects and embodiments of the invention, the terpene concentration is enhanced because it is using the same glass tube during the infusion and the packing process. The enhancement is due to the glass tube being previously filled by saturated terpene, thus minimizing the degradation of the terpene. Using different glass tubes for packaging causes a higher possibility of terpene degradation.

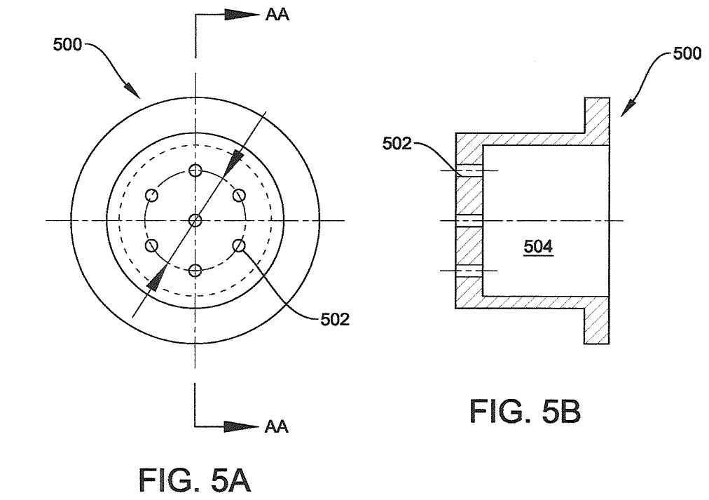

Referring now to FIG. 5A and FIG. 5B, a cap insert 500, which fitted into a cap (not shown) that matingly fits onto a glass or plastic container, is shown in accordance with various aspects and embodiments of the invention. The cap insert 500 includes openings 502 and a cavity 504. In accordance with the various aspects and embodiments of the invention, the cap insert 500 is made of a material that has a low porosity to avoid dissipation, such as PTFE (Teflon). In accordance with the various aspects and embodiments of the invention, the cap insert 500 is coated with a material such as PTFE. This application causes a greater concentration of the terpene into the pre-rolled cone that is inside the glass or plastic container. As noted, and in accordance with the various aspects of the invention, the cap insert 500 can be made with plastic, rubber, or any material that is suitable to avoid a dissipation.

In accordance with the various aspects and embodiments of the invention, the insert 500 is made of a rubber compound that has higher porosity, which results in absorption of the terpene into the rubber and reduces the amount that is absorbed into the cone paper while the cone paper is inside the glass tube.

The scope of the invention, therefore, is not intended to be limited to the exemplary embodiments and aspects that are shown and described herein. Rather, the scope and spirit of the invention is embodied by the appended claims.

What is claimed is:

1. A method for preparing a terpene-infused glue for manufacturing pre-rolled cones, the method comprising:
combining terpenes with polypropylene glycol to produce a first solution;
mixing the first solution using a vortex for a first predefined period of time to produce a mixed first solution;
combining the mixed first solution with at least one of a starch-based glue and an Ethyl Vinyl Acetate (EVA) glue at a predefined ratio to produce a second solution; and
mixing the second solution using the vortex for a second predefined period of time to produce a homogenized glue solution.

2. The method of claim 1, wherein the first predefined period of time is at least three minutes.

3. The method of claim 1, wherein the second predefined period of time is at least three minutes.

4. The method of claim 1, wherein the vortex results in a centrifuge force of at least 1500 G.

5. The method of claim 1, wherein the predefined ratio is based on % weight of the terpenes, the polypropylene glycol, and the at least one of the starch-based glue and the Ethyl Vinyl Acetate (EVA) glue.

6. A system for infusing pre-rolled cones with terpene derivative products. the system comprising:
a container;
a precoated cap, wherein the cap matingly fits onto the container; and
an infused insert, wherein the insert fits within the cap,
wherein the insert includes a concentrated terpene solid material and the insert is placed within the cap and the cap is sealed onto the container,
wherein the pre-rolled cone is placed inside the container and sealed inside the container by the cap, and
wherein the insert within the cap releases terpene inside the container and the terpene is infused into the pre-rolled cone.

7. The system of claim 6 wherein the container is at least one of a precoated glass and a precoated plastic container.

8. The system of claim 7, wherein the precoated glass is coated with Teflon.

9. The system of claim 7, wherein the precoated plastic container is coated with Teflon.

10. The system of claim 6, wherein the cap is coated with a low porosity material.

11. The system of claim 10, wherein the low porosity material is Teflon.
